(19) United States
(12) Patent Application Publication
(10) Pub. No.: US 2007/0089513 A1
(43) Pub. Date: Apr. 26, 2007

(54) Resonator based transmitters for capacitive sensors

(76) Inventors: Steven A. Rosenau, Mountain View, CA (US); Michael Louis Frank, Loveland, CO (US)

Correspondence Address: AVAGO TECHNOLOGIES, LTD., P.O. BOX 1920, DENVER, CO, 80201-1920, US

(21) Appl. No.: 11/239,825

(22) Filed: Sep. 30, 2005

(51) Int. Cl. G01P 15/125

(52) U.S. Cl. 73/514.32

(57) ABSTRACT

Oscillator circuits formed using various different topologies can be used to generate signals depending on the capacitance of a capacitive sensor. The sensor capacitance is used to pull the resonance frequency of a resonator included in an oscillator circuit. As the capacitance changes, the oscillator frequency changes in direct relation. The oscillator signal is then transmitted via a suitable transmission link to a receiver, where it is recovered and processed as desired.

### BACKGROUND

Numerous devices use one or more sensors to detect, monitor, and/or measure physical phenomena associated with the devices, aspects of the environment in which devices are operated, or the manner in which the devices are operated. As these devices become more complex, feature-rich, and in some cases more portable, limits on sensor size and resource requirements are becoming more strict. Many of these sensors are built into devices demanding low power consumption, varying duty cycles, robust operation, and long-term stability. Because such sensors are increasingly deployed in numerous different locations or types of locations within a device, the sensors should also utilize robust mechanisms for communicating sensor values to relevant display or control circuitry.

There are many different examples of micromachined mechanical transducers that can be employed as MEMS sensors. Among these sensing mechanisms are devices that rely on the following effects: piezoresistivity, piezoelectricity, variable capacitance, optical, and resonant techniques. Similarly, many sensors use (either directly or indirectly) mechanical actuation methods, including electrostatic, piezoelectric, thermal, and magnetic methods.

Capacitive techniques are often employed in MEMS sensors because the physical structures needed are relatively simple, while capacitive sensing techniques still provide precise ways of sensing the movement of an object or material.

With the ability to cause a sensor's capacitance to change in reaction to a physical phenomenon comes the need to measure the capacitance and deliver measured capacitance values to relevant display or control circuitry. As noted above, this often needs to be performed in a way that meets the overall performance criteria of the sensor system, e.g., small size, low power, etc. For example, some MEMS-based capacitive sensors relay their data through RF signals. Various low power radios have been developed to transmit capacitance information to a corresponding receiver, however such devices typically operate in microwave bands utilizing crystal oscillators and phase-locked loops that use considerable power and can require significant start-up time for operation.

### SUMMARY

In accordance with the invention, oscillator circuits formed using various different topologies can be used to generate signals depending on the capacitance of a capacitive sensor. The sensor capacitance is used to pull the resonance frequency of a resonator included in an oscillator circuit. As the capacitance changes, the oscillator frequency changes in direct relation. The oscillator signal is then transmitted via a suitable transmission link to a receiver, where it is recovered and processed as desired.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

FIGS. 1A-1C illustrate several different embodiments of capacitive sensor signal transmission systems in accordance with the invention.

FIGS. 2A-2B illustrate an example of a film bulk acoustic resonator (FBAR) and an equivalent circuit.

FIG. 3 illustrates a schematic diagram of an oscillator circuit for use in capacitive sensor signal transmission systems in accordance with the invention.

FIG. 4 illustrates a more detailed schematic diagram of an oscillator circuit for use in capacitive sensor signal transmission systems in accordance with the invention.

FIG. 5 illustrates another schematic diagram of an oscillator circuit for use in capacitive sensor signal transmission systems in accordance with the invention.

### DETAILED DESCRIPTION

The following sets forth a detailed description of the best contemplated mode for carrying out the invention. The description is intended to be illustrative of the invention and should not be taken to be limiting.

Throughout this application, reference will be made to various MEMS sensor devices, designs and fabrication processes for which will be well known to those skilled in the art. Many of these processes and techniques are borrowed from semiconductor device fabrication technology, e.g., photolithography techniques, thin film deposition and growth techniques, etching processes, etc., while other techniques have been developed and/or refined specifically for MEMS applications. Additionally, the devices and methods described in the present application can also be used in conjunction with capacitively monitored sensors that are not, strictly speaking, MEMS devices. In short, the presently disclosed devices and techniques can generally be used in conjunction with any sensor device that produces a varying capacitance according to the quantity or effect it is detecting.

As noted above, the structures of capacitive sensors can be relatively simple, and generally rely determining a change in capacitance as some portion of the capacitive sensor (e.g., portions corresponding to one or more capacitor electrodes or the capacitor dielectric) moves. Capacitive sensors are generally characterized by certain nonlinear behavior and temperature dependence, but these effects can often be accommodated by careful design and/or integration of suitable signal conditioning circuitry close to the sensor. For example, the capacitance of a simple parallel plate capacitor structure (ignoring fringing fields and other effects) is given by

$$C = \frac{{ɛ}_{0} {ɛ}_{r} A}{d} ,$$

where ε₀ is the permittivity of free space, εᵣ is the relative permittivity of the dielectric material between the electrodes, A is the area of overlap between the electrodes, and d is the distance between the electrodes.

The expression describing capacitance demonstrates that the capacitance can be varied by changing one or more of the other variables. In an example, one electrode of the capacitor fabricated in a fixed position, while the other electrode is allowed to move in response to some stimulus. The movement of the electrode can be configured such that it moves toward or away from the fixed electrode, thereby varying the separation d, and changing the capacitance inversely. If instead electrode movement is lateral, the value of d remains constant, but the area of overlap A changes, producing a linear change in capacitance. In still another example, the electrodes remain in a fixed position, and the dielectric material between the electrodes is allowed to move, thereby changing the capacitance by altering the effective permittivity of the material between the electrodes.

While a parallel plate capacitor provides a useful example, capacitive sensors need not be constructed so as to strictly adhere to this architecture. Thus, numerous capacitive devices and geometries can be implemented including, for example, differential capacitance sensors (useful for canceling out other effects like temperature dependence), sensors with more than two electrodes, sensors where one or both of the electrodes are formed by liquid metal droplets or slugs whose flow (and therefore relative position) effect capacitance, sensors where the capacitor plates are co-planar and situated next two each other, and the like. In the case of capacitive sensors using liquid metal, examples of suitable liquid metals include mercury, gallium alloys, and indium alloys. Other examples of suitable liquid metals, e.g., with acceptable conductivity, stability, and surface tension properties, will be known to those skilled in the art. In general, those skilled in the art will recognize a variety of different capacitor sensor configurations that can be implemented.

MEMS techniques are particularly useful for constructing capacitive sensors because they allow for the construction of compact yet sensitive moving parts. For example, MEMS techniques are well suited for membrane-type devices which are often used as the basis for pressure sensors and microphones. More elaborate structures, such as interdigitated capacitors can also be fabricated, although the parallel plate capacitor model may not be adequate to characterize their behavior. Capacitive techniques are generally less noisy than many other sensor techniques, such as those based on piezoresistance, since they are not susceptible to thermal noise. However, micromachined capacitive devices typically have very small capacitance values, e.g., on the order of 10⁻¹⁵ to 10⁻¹⁸ farads, increasing the possibility that noise from interface electronic circuits will swamp their signal.

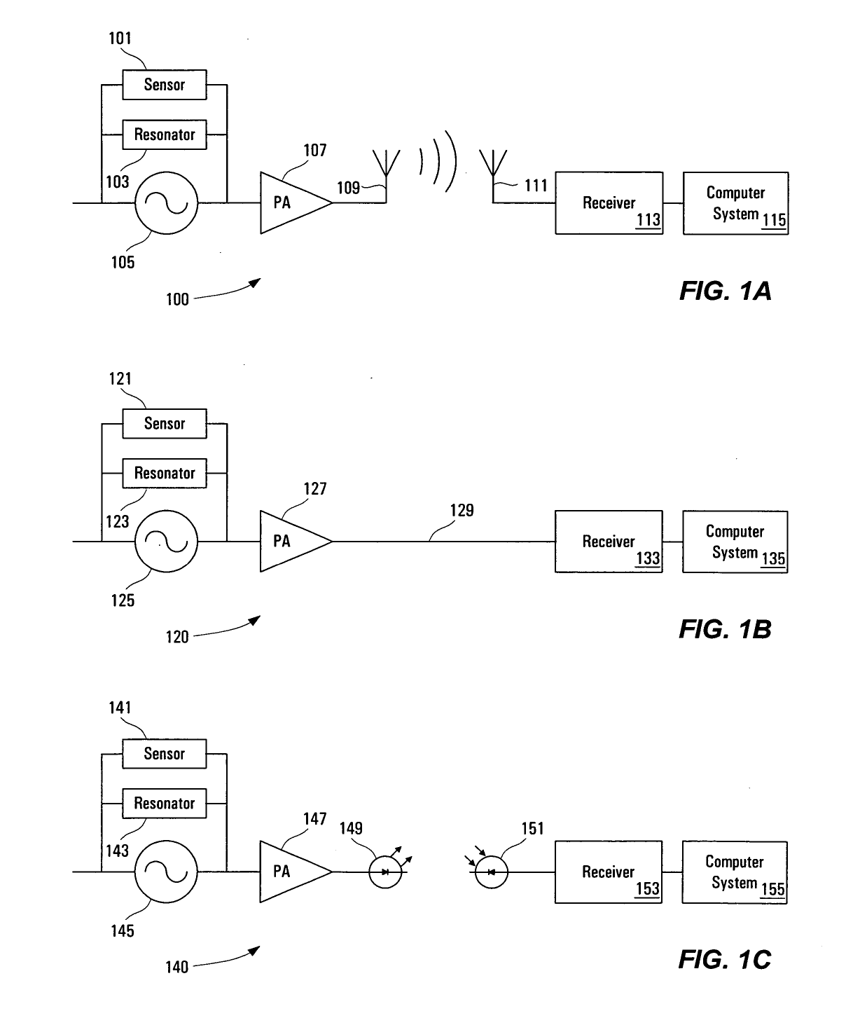

FIG. 1A illustrates an embodiment of a capacitive sensor signal transmission system in accordance with the invention. Sensor system 100 includes a capacitively monitored sensor 101, e.g., a capacitive sensor fabricated using MEMS techniques. Sensor 101 is located within a particular device so as to accurately detect or measure some environmental quality such as temperature, pressure, acceleration, tilt, or the like. Instead of using conventional capacitance measuring techniques, such as charge amplifiers, charge balance techniques, and ac bridge impedance, direct conversion of sensor 101's capacitance to an RF signal is provided by coupling sensor 101 to an appropriate resonator circuit 103. Resonator 103 in turn is part of an oscillator circuit 105. The capacitance of sensor 101 is applied to resonator 103, detuning the circuit and causing frequency pulling of the oscillator. As the capacitance of sensor 101 changes in response to the stimulus it is monitoring, the oscillator frequency changes in direct relation. The combination provides what is essentially a capacitance to frequency conversion. Depending on the nature of the capacitive sensor, changes in capacitance can be continuous or discrete (either monotonic or with varying scales).

As shown in system 100, this signal can then be suitably amplified using power amplifier 107, and broadcast wirelessly via antenna 109. In some embodiments in accordance with the present invention, the inherent signal strength of the signal produce by oscillator 105 may be such that amplifier 107 is unneeded. Moreover, when amplifier 107 is implemented in system 100, various different amplifier circuits and techniques can be used as appropriate for the signals involved and the transmission technique employed. As shown, system 100 utilizes a wireless RF transmission scheme. Thus, antenna 111 receives the RF signal transmitted by antenna 109. That signal is then recovered by receiver circuit 113 and forwarded to other circuitry for additional processing, such as computer system 115. Receiver circuit 113 essentially demodulates the received signal to convert the varying frequency signal to a dc value. In many examples, computer system 115 is a simple data processing system designed to monitor, record, and/or display sensor values. In general, computer system 115 can be as simple or as complex as required by the sensing application. Moreover, various components of system 100 can be integrated together as will be known to those skilled in the art.

While the design of system 100 is generally driven by the need to extract and transmit sensor values, system 100 also illustrates a wireless transmission scheme as compared with many other wireless transmission schemes. In many wireless systems, the local oscillator signal is generated through frequency synthesis. Frequency synthesis circuits typically employ frequency multiplication of lower-frequency crystal oscillators via feedback techniques such as phase lock loops (PLLs). However, such frequency synthesizers can have degraded phase noise because of the voltage-controlled oscillator's low quality factor and because of the finite loop bandwidth of the PLL. Moreover, such frequency synthesizers often require significant power in the oscillator and frequency dividers, a particular problem as the carrier frequency increases due to application requirements, antenna geometry, etc. Frequency synthesizers may also be relatively inefficient, and have relatively long startup times. Thus, system 100 is simpler in that the resonator based oscillator directly generates the desired RF frequency, and that frequency is readily detuned according to sensor values.

While system components such as resonator 103, oscillator 105, amplifier 107, and antenna 109, can be fabricated using conventional semiconductor integrated circuit designs and techniques (e.g., CMOS, Bipolar, BiCMOS, etc.) some or all of the components can also be fabricated using MEMS designs and techniques. For example, resonator 103 can be implemented using a variety of different resonator circuits and devices including, LC tank circuits, crystal resonators, surface acoustic wave (SAW) resonators, film bulk acoustic resonators (FBARs), and other micromechanical resonators.

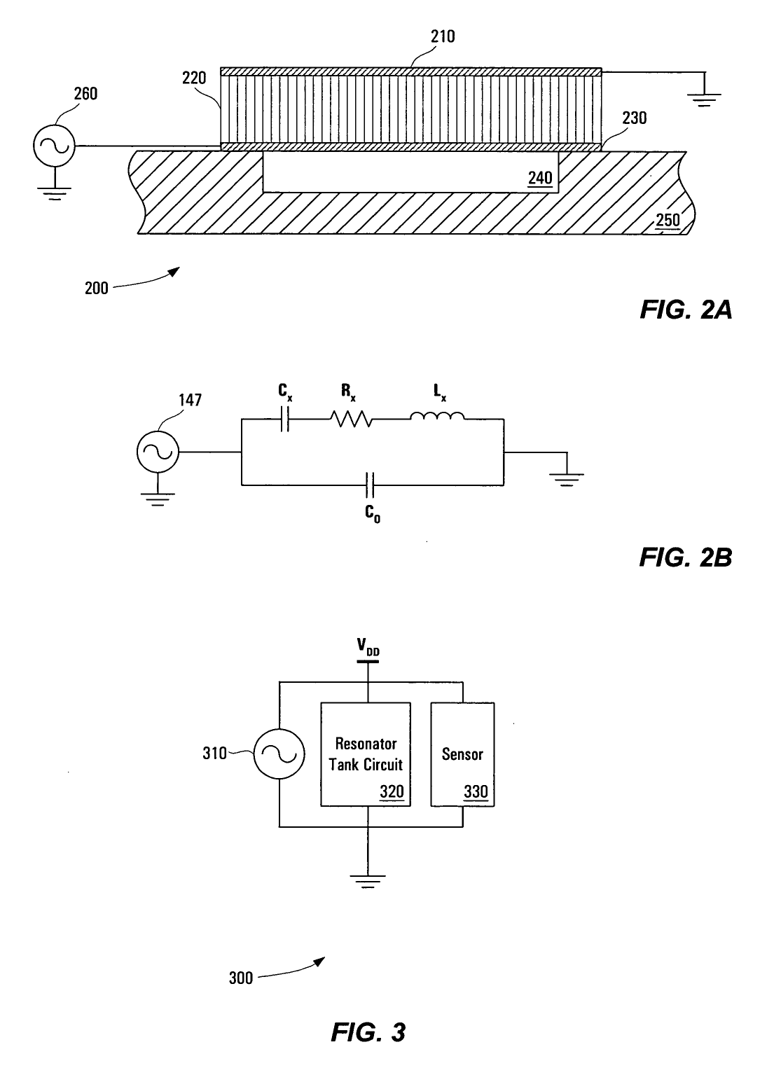

In many embodiments in accordance with the invention, resonator 103 is implemented using an FBAR device. FIG. 2A illustrates an example of such a device. FBAR 200 is formed from a thin film piezoelectric layer 220 that is sandwiched between a pair of electrodes 210 and 230. Piezoelectric layer 220 can be formed from a variety of piezoelectric materials such as aluminum nitride (AlN), lead zirconate titanate (PZT), zinc oxide (ZnO), polyvinylidene fluoride (PVDF) polymer films, quartz, lithium niobate (LiNbO₃), or other suitable materials. Electrodes 210 and 230 are fabricated from a metal that is compatible with the selected piezoelectric material and suited to the FBAR fabrication process. Examples include metals such as molybdenum, aluminum, tungsten, gold, silver, titanium, as well as various alloys. The sandwich structure is suspended over cavity 240 which is formed within substrate 250. FBAR 200 is typically fabricated using conventional silicon micromachining techniques, but various MEMS and semiconductor fabrication processes can also be used. Voltage supply 260 applies an electric field between electrodes 210 and 220. Thin film piezoelectric layer 220 converts a portion of the applied electrical energy into mechanical energy in the form of acoustic waves. These acoustic waves propagate in the direction of the applied electric field and reflect off the interface between cavity 240 and electrode 230. They then return through thin film piezoelectric layer 220 and re-reflect off the interface between electrode 210 and the atmosphere above the device. FBAR 200 possesses a mechanical resonant frequency corresponding to the frequency at which the half wavelength of an acoustic wave propagating in the device is approximately equal to the total thickness of the device for a given speed of sound in the FBAR device.

FBARs can achieve high-frequency tightly controlled resonance with an unloaded series resonant Q value of 1000 or greater. As shown in FIG. 2B, the resonator can be modeled as a series LCR circuit, with a series resonance occurring at ωₛ=(LₓCₓ)^{-1/2}, where Lₓ and Cₓ are effective inductance and capacitance respectively. Rₓ represents the motional resistance of the device, which generally depends on piezoelectric material properties and device area. Capacitance C₀ models the parasitic feed through capacitance created by the parallel plates of the resonator. FBAR devices such as device 200 are can be fabricated to be relatively small, e.g., 10,000 μm², and either integrated with other parts of the sensor system (e.g., the sensor itself and other circuit elements) or wire bonded directly to an integrated circuit containing other system circuitry.

Returning to FIG. 1A, system 100 shows sensor 101 (e.g., the capacitance produced by sensor 101) coupled in parallel with resonator 103. Since the effective capacitance of resonator 103 will typically be larger (e.g., an order of magnitude larger) than the capacitance of sensor 101, it is preferred that the two be coupled in parallel so that their capacitances are added together, rather than allowing the relatively small capacitance of sensor 101 to dominate in the case of series coupling. However, in some embodiments in accordance with the invention, the size of the relative capacitances and/or other system design features may suggest series coupling. Moreover, it may also be desirable to carefully design resonator 103 with circuit features or sensor features in mind. Careful joint optimization may be desirable to achieve reduced power consumption, low noise, etc.

FIG. 1B illustrates another embodiment of a capacitive sensor signal transmission system in accordance with the invention. Sensor system 120 includes a capacitively monitored sensor 121 coupled in parallel with resonator 123. Resonator 123 is part of an oscillator circuit 125, which produces an RF signal whose frequency is pulled by the capacitance of sensor 121. As the capacitance of sensor 121 changes in response to the stimulus it is monitoring, the oscillator frequency changes in direct relation. As shown in system 120, this signal can then be suitably amplified using power amplifier 127, and transmitted via transmission line 129. In some embodiments in accordance with the present invention, the inherent signal strength of the signal produce by oscillator 125 may be such that amplifier 127 is unneeded. Moreover, when amplifier 127 is implemented in system 120, various different amplifier circuits and techniques can be used as appropriate for the signals involved and the transmission technique employed. Transmission line 129 is configured and fabricated to meet the needs of system 120, and thus may include multiple segments, intervening connectors, wires, integrated circuit conductors, PCB traces, microstrip transmission lines, microshield transmission lines, coplanar waveguides, etc. The signal transmitted along transmission line 129 is then recovered by receiver circuit 133 and forwarded to other circuitry for additional processing, such as computer system 135. In many examples, computer system 115 is a simple data processing system designed to monitor, record, and/or display sensor values. In general, computer system 115 can be as simple or as complex as required by the sensing application. Apart from the nature of the transmission scheme, system 120 operates in a manner similar to system 100 of FIG. 1A. However, as will be known by those skilled in the art, the specific implementation of transmission line 129 may suggest or dictate certain implementation changes in other system components.

FIG. 1C illustrates yet another embodiment of a capacitive sensor signal transmission system in accordance with the invention. Sensor system 140 includes a capacitively monitored sensor 141 coupled in parallel with resonator 143. Resonator 143 is part of oscillator circuit 145, which produces an RF signal whose frequency is pulled by the capacitance of sensor 141. As the capacitance of sensor 141 changes in response to the stimulus it is monitoring, the oscillator frequency changes in direct relation. This signal can then be suitably amplified using power amplifier 147, and transmitted via an optical transmission link formed by light emitting diode (LED) 149 and photodiode 151. In some embodiments in accordance with the present invention, the inherent signal strength of the signal produce by oscillator 145 may be such that amplifier 147 is unneeded. Moreover, when amplifier 147 is implemented in system 140, various different amplifier circuits and techniques can be used as appropriate for the signals involved and the transmission technique employed. The optical transmission link formed by LED 149 and photodetector 151 is typically employed where it is desirable to electrically isolate the transmitter and receiver portions of the system. Photodiode 149 produces optical output corresponding to a driving signal based on the capacitance of sensor 141, and thus additional driving circuitry (not shown) can also be included in system 140. Light generated by LED 149 is detected by photodetector 151, and converted into a suitable signal recovered by receiver circuit 153 and forwarded to other circuitry for additional processing, such as computer system 155. Various different optical and electro-optical components, e.g., lenses, fibers, LEDs, laser diodes, PIN photodiodes, PN photodiodes, and avalanche photodiodes can be used.

FIGS. 1A-1C illustrate several different transmission path types (i.e., wireless radio, wired, and optical), but numerous different transmission paths and transmission schemes, as well as variations on those disclosed, will be known to those skilled in the art.

Various different oscillator circuits and topologies can be used to implement the systems illustrated in FIGS. 1A-1C, but most can be generally described as resonant tank tuned oscillators. Resonant tank tuned oscillators are particularly useful for wireless systems because they can provide lower phase noise due to the higher energy storage capability (i.e., the high Q factor) of LC tanks or their equivalent. Low voltage operation is generally desirable for sensor applications, and single-ended or differential topologies can be chosen. Single-ended topologies are generally simpler to implement and may require less power than differential topologies, but differential topologies have the added advantages of (1) inherently lower sensitivity to common-mode noise, and (2) providing a larger output swing when the supply voltage limits the swing.

FIG. 3 illustrates a schematic diagram of an oscillator circuit for use in capacitive sensor signal transmission systems in accordance with the invention. More specifically, circuit 300 includes oscillator components (illustrated schematically as 310) such as passive and active components. In circuit 300, the traditional LC tank circuit common to many oscillator designs is instead illustrated as a resonator tank circuit 320 coupled in parallel with the sensor capacitance 330. Although resonator tank circuit 320 can be implemented as a simple LC tank, it is more generally represented as a resonator tank circuit because it can be fabricated using various different resonators such as LC tank circuits, crystal resonators, SAW resonators, FBARs, and other micromechanical resonators. Although sensor 330 is shown coupled in parallel with a corresponding resonator tank circuit, this need not be the case. Since the effective capacitance of a resonator will typically be larger than the capacitance of a sensor, parallel coupling may be preferred in some implementations as noted above. In other embodiments in accordance with the invention, the size of the relative capacitances and/or other system design features may suggest series coupling of the sensors and corresponding resonators.

Circuit 300 can be implemented as a so-called “one-transistor” device. While most discrete RF oscillators are implemented using only a single active device (e.g., to minimize noise and lower cost), many of the oscillator circuits in accordance with the invention will be implemented as integrated circuits, or at least partially integrated circuits, i.e., with the resonator (in the case of some MEMS resonators) and/or the sensor separately fabricated.

Circuit 300 can be implemented using bipolar transistors or field effect transistors. Various different feedback schemes can be implemented as will be known in the art. For example, if the resonator tank circuit is conceptualized as an inductor and capacitor in parallel, the impedance of the tank circuit is real at resonance. Consequently, the phase difference between its current and voltage is zero, and to achieve a total phase equal to zero, a feedback signal is returned to the appropriate transistor terminal (e.g., to the emitter of a bipolar transistor). A direct feedback path from the tank circuit to the transistor will typically have to contend with resistive loading seen at the emitter/source terminal, i.e., the inverse of the transistor's transconductance. Simply applying the collector/drain voltage to the emitter/source typically reduces the Q value of the tank because of the resistance. Instead, various oscillator topologies transform the emitter/source impedance to a higher value before it appears in parallel with the tank. The desired impedance transformation can be achieved with passive components using either capacitive or inductive dividers. More sophisticated implementations comprise an integrated circuit with multiple active and passive devices.

Oscillator circuits that use a capacitive divider are generally referred to as a Colpitts oscillators, while those using inductive dividers are referred to as Hartley oscillators. The tank circuit for a Colpitts oscillator typically includes one inductor in parallel with two capacitors, and the feedback to the transistor's emitter/source is tapped at the node between the two capacitors. The capacitive transformer is formed by capacitor pair, and the feedback to the transistor establishes the positive feedback needed for oscillation. As will be understood by those skilled in the art, the specific details of circuit implementation will vary depending on the type of resonator circuit employed, and the specific oscillator topology utilized. Examples of other oscillator topologies in accordance with the invention include Pierce and Butler oscillators. Still other oscillator topologies and their variations depending on transistor implementation (e.g., bipolar v. CMOS) will also be known to those skilled in the art.

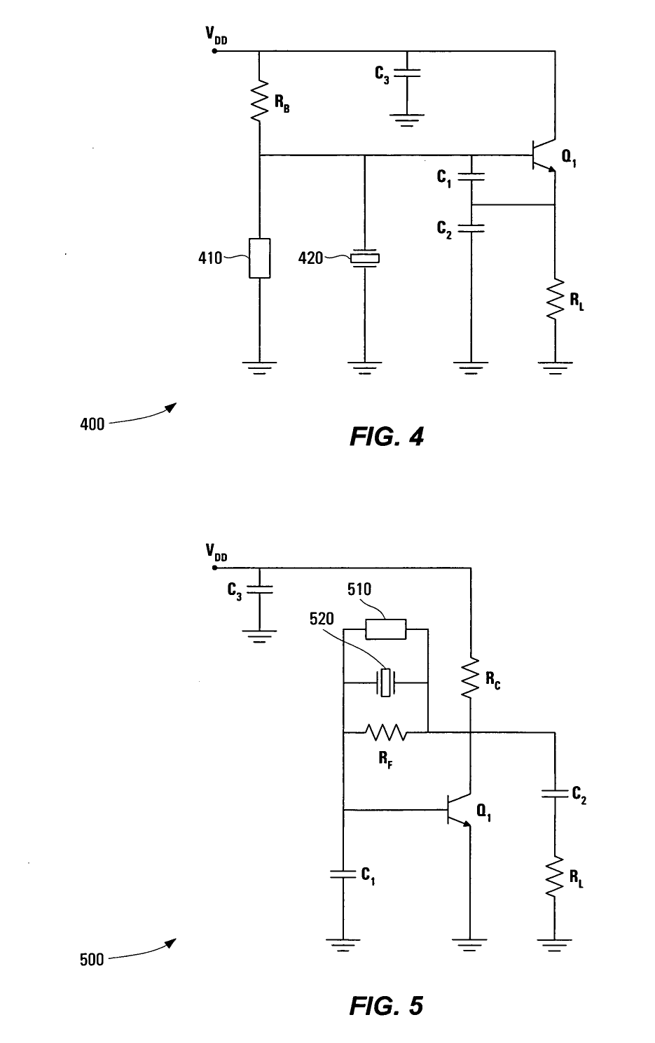

FIG. 4 illustrates a more detailed schematic diagram of an oscillator circuit for use in capacitive sensor signal transmission systems in accordance with the invention. In this example, a bipolar oscillator is stabilized with a resonator, e.g., a MEMS resonator such as an FBAR. Similar designs can be implemented in CMOS processes as well.

Oscillator 400 is a Colpitts oscillator where the resonator (420) is used essentially as an inductor. Sensor 410 uses its capacitance to pull the resonance frequency of the oscillator as described above.

Thus, one side of resonator 420 is tied to ground and the resonator is resonant with the combination of capacitor C₁ in series with capacitor C₂. At circuit resonance, assuming the reactive elements dominate the circuit impedances, the base to emitter voltage gain provided by the tank circuit formed by resonator 420 and capacitors C₁ and C₂ is 1+C₁/C₂. The reactance of C₂ is typically chosen to be greater than that of the load, represented by resistor R_{L}. Transistor Q₁, used in an emitter follower configuration, supplies less than unity gain to sustain oscillation, and the output signal can be taken directly off C₂. In some embodiments in accordance with the invention, the load can be placed in series with resonator 420 as long as the resonator impedance is significantly larger than the load. Although typical implementations are designed to operate resonator 420 in a fundamental mode, some implementations can operate on an overtone by, for example, replacing one of C₁ or C₂ with an LC tank circuit.

FIG. 5 illustrates another oscillator implementation based on the well known Pierce topology. Oscillator 500 is a Pierce oscillator with a fundamental mode resonator 520 (e.g., and FBAR) pulled by the capacitance of sensor 510. Like oscillator 400 of FIG. 4, this circuit uses resonator 520 as an inductive element. The value of resistor R_{C} is usually chosen for the desired dc bias current. For example, if the value of R_{F} is chosen to be approximately 50 times that of R_{C}, then the transistor will be biased with the collector voltage (dc) at approximately half of the supply voltage. The ratio of oscillation amplitude (collector to base) is approximately C₁/C₂, and so the value of C₁ is typically chosen to dominate the transistor input impedance. Making C₂ two to five times smaller than C₁ can create a large oscillation amplitude at the collector, providing a good impedance match to the load R_{L}. In general, the resonator is designed to be resonant with the series capacitance of C₁ and C₂ at the desired operation frequency. As with the oscillator 400, other implementations of oscillator 500 can utilize resonator overtones.

The Colpitts and Pierce oscillator designs are two common oscillator designs because they use few components, are relatively easy to design, and are generally capable of high performance. Nevertheless, similar implementations can be constructed using other oscillator topologies and known variations on such oscillator topologies.

Numerous variations and modifications to the circuits described in FIGS. 1A-1C and 3-5 will be known to those skilled in the art. For example, many of the resistors illustrated can be implemented using a variety of programmable and/or trimable devices. Similarly, the disclosed devices and techniques are not necessarily limited by any transistor, resistor, capacitor, or other component size or by voltage levels disclosed herein. Moreover, implementation of the disclosed devices and techniques is not limited by process technology, and thus implementations can utilize CMOS, NMOS, PMOS, and various bipolar or other semiconductor fabrication technologies. While the disclosed devices and techniques have been described in light of the embodiments discussed above, one skilled in the art will also recognize that certain substitutions may be easily made in the circuits without departing from the teachings of this disclosure. For example, many circuits using bipolar transistors may be implemented using NMOS or PMOS transistors instead, as is well known in the art. In this vein, the transistor conductivity type (i.e., N-channel or P-channel) within a CMOS circuit may be frequently reversed while still preserving similar or analogous operation.

Regarding terminology used herein, it will be appreciated by one skilled in the art that any of several expressions may be equally well used when describing the operation of a circuit including the various signals and nodes within the circuit. Any kind of signal, whether a logic signal or a more general analog signal, takes the physical form of a voltage level (or for some circuit technologies, a current level) of a node within the circuit. Such shorthand phrases for describing circuit operation used herein are more efficient to communicate details of circuit operation, particularly because the schematic diagrams in the figures clearly associate various signal names with the corresponding circuit blocks and node names.

Those skilled in the art will readily recognize that a variety of different types of components and materials can be used in place of the components and materials discussed above. Moreover, the description of the embodiments in accordance with the invention set forth herein is illustrative and is not intended to limit the scope of the invention as set forth in the following claims. Variations and modifications of the embodiments disclosed herein may be made based on the description set forth herein, without departing from the scope and spirit of the invention as set forth in the following claims.

What is claimed is:

1. An apparatus comprising:
a sensor operable to produce a capacitance in response to a stimulus;
a resonator coupled to the sensor;
an oscillator circuit, wherein the oscillator circuit further comprises the resonator; and
a transmission path coupled to the oscillator circuit and operable to transmit a signal corresponding to the capacitance of the sensor.

2. The apparatus of claim 1 wherein the sensor is further operable to produce the capacitance in response to at least one of: acceleration, pressure, temperature, humidity, tilt, force, fluid flow, and material pH.

3. The apparatus of claim 1 wherein the sensor further comprising a microelectromechanical device.

4. The apparatus of claim 3 wherein the microelectromechanical device further comprises at least one of an electrode that moves in response to the stimulus and a dielectric material that moves in response to the stimulus.

5. The apparatus of claim 1 wherein the resonator further comprises at least one of: an LC tank circuit, a crystal resonator, a surface acoustic wave (SAW) resonator, and a film bulk acoustic resonator (FBAR).

6. The apparatus of claim 1 wherein the capacitance produced by the sensor is coupled in one of: series with the resonator and parallel with the resonator.

7. The apparatus of claim 1 wherein the capacitance produced by the sensor pulls the resonant frequency of the oscillator.

8. The apparatus of claim 1 wherein the resonator operates as a tank circuit in the oscillator circuit.

9. The apparatus of claim 1 wherein the resonator operates as a component of a tank circuit in the oscillator circuit.

10. The apparatus of claim 1 wherein the oscillator circuit is at least one of a Colpitts oscillator, a Pierce oscillator, a Hartley oscillator, and a Butler oscillator.

11. The apparatus of claim 1 wherein the transmission path coupled to the oscillator circuit further comprises at least one of: a transmission line, an antenna, an electro-optical component, and an optical component.

12. A method comprising:
varying a capacitance in response to a sensed environmental condition;
adjusting the resonant frequency of a resonator using the capacitance; and
generating a signal corresponding to the capacitance using the adjusted resonant frequency of the resonator.

13. The method of claim 12 further comprising:
amplifying the signal in preparation for transmission of the signal.

14. The method of claim 12 further comprising:
transmitting the signal using at least one of: a transmission line, an antenna, and an optical component.

15. The method of claim 12 wherein the sensed environmental condition further comprises at least one of: acceleration, pressure, temperature, humidity, tilt, force, fluid flow, and material pH.

16. The method of claim 12 wherein the varying the capacitance further comprises at least one of:
moving an electrode in response to the environmental condition; and
moving a dielectric material in response to the environmental condition.

17. The method of claim 12 wherein the adjusting the resonant frequency of the resonator further comprises one of:
applying the capacitance in parallel with the resonator; and
applying the capacitance in series with the resonator.

18. The method of claim 12 wherein the resonator further comprises at least one of: an LC tank circuit, a crystal resonator, a surface acoustic wave (SAW) resonator, and a film bulk acoustic resonator (FBAR).

19. The method of claim 12 wherein the generating the signal further comprises:
producing an oscillating signal using at least one of a Colpitts oscillator, a Pierce oscillator, a Hartley oscillator, and a Butler oscillator.

20. An apparatus comprising:
a means for varying a capacitance in response to a sensed environmental condition;
a means for adjusting the resonant frequency of a means for resonating using the capacitance; and
a means for generating a signal corresponding to the capacitance using the adjusted resonant frequency of the means for resonating.
